(19) United States
(12) Patent Application Publication
(10) Pub. No.: US 2023/0397769 A1
(43) Pub. Date: Dec. 14, 2023

(54) NESTABLE CONTAINERS

(71) Applicant: TidyBoard LLC, San Francisco, CA (US)

(72) Inventors: Matthew Charles, San Francisco, CA (US); Mark Van Velzen, Lafayette, CA (US); William Charles, Reno, NV (US)

(73) Assignee: TidyBoard LLC, San Francisco, CA (US)

(21) Appl. No.: 18/456,974

(22) Filed: Aug. 28, 2023

Related U.S. Application Data
(63) Continuation-in-part of application No. 18/150,124, filed on Jan. 4, 2023, now Pat. No. 11,737,608.
Application No. 18/150,124 is a continuation of application No. 16/885,664, filed on May 28, 2020, now Pat. No. 11,571,091.
(60) Provisional application No. 62/853,394, filed on May 28, 2019.

(51) Int. Cl. A47J 47/00; A47J 47/14; A47J 47/16

(52) U.S. Cl. CPC A47J 47/005; A47J 47/14; A47J 47/16

(57) ABSTRACT

Nestable containers are provided for installation within a compatible cutting board or for stand-alone use. A first container features a lip along at least part of a circumference of the container, and a ledge below the lip that also extends along at least part of the circumference. A second container features a cooperative lip that, when the second container is nested within the first container, engages or rests upon the ledge of the first container. The lips and/or the ledge may be continuous or discontinuous.

### RELATED ART

This is a continuation-in-part of and claims priority to U.S. patent application Ser. No. 18/150,124 (the '124 application; Attorney Docket TB-001C2), and the '124 application claims priority to U.S. patent application Ser. No. 16/885,664 (the '664 application; Attorney Docket TB-001), in accordance with 35 U.S.C. § 120. The '664 application was filed 28 May 2020 and claims priority under 35 U.S.C. § 119 to U.S. Provisional Application No. 62/853,394, which was filed 28 May 2019. The contents of the preceding applications are incorporated herein by reference in their entirety.

### BACKGROUND

This disclosure relates to the field of consumer goods. More particularly, nestable containers are provided for various uses, including with a cutting board that features at least one cut-out for accommodating the containers.

Existing cutting boards often provide mediocre user experiences during food preparation due to their limited surface area, which can quickly become cluttered with prepared ingredients, scraps, containers, etc. For example, some ingredients or scraps may need to be thrown away or composted, others may need to be washed or strained, others may need to be stored, while others may be intended for immediate use. Existing cutting boards generally do not assist a user in separating, sorting, or transporting the items for their intended dispositions. Instead, a user may need to awkwardly transfer items between the board and various containers placed around the area in which the cutting board is being used.

Also, containers for food ingredients and/or scraps are often designed such that they cannot be easily combined or used in a cooperative manner by themselves and/or with other equipment. For example, it is cumbersome to add contents to two or more individual and separate containers during preparation of a meal or during some other activity. Also, or instead, one container (e.g., when filled) may need to be exchanged for an empty container, thereby interrupting the workflow.

### SUMMARY

In some embodiments, a cutting board described herein features one or more cut-out sections, bores, or voids. The cutting board may be situated such that while some or most of the board is supported by a counter or other underlying support, a cut-out may be located past an edge of the support. One or more removable and nestable/stackable containers fit into a cut-out such that their outer edges substantially align with a border of the cut-out; for example, they may be configured to closely fit the border of the cut-out, which may feature a lip or ledge for engaging and supporting edges of the containers. While the cutting board is in use, items may be easily transferred from a cutting surface by brushing or scraping them into the one or more containers. Lids may be provided for some or all containers.

In some embodiments, a cutting board features a single cut-out into which multiple containers are nested or stacked, and different containers may be used for different purposes. For example, one may receive items that are to be stored, another may receive items to be composted, another may act as a strainer, and so on. In addition, when installed in the cut-out, top edges of the installed containers may be substantially coplanar with the surface of the cutting board. Because none of the containers extend above the cutting surface, there is little or no impediment to the movement of items from the working area to the containers. In particular, the items need not be lifted from the cutting board in order to be placed in a container.

In other embodiments, nestable containers are provided for use with a compatible cutting board, another piece of equipment, or for stand-alone use. In these embodiments, a nestable container features external protrusions or lips around all or a portion of its upper rim, or a single continuous protrusion around all or a portion of the upper rim. Also, or alternatively, a nestable container features inner ledges or platforms around all or a portion of its upper rim, or a single continuous inner ledge around all or a portion of the upper rim. Thus, an external protrusion of one container is configured to engage with a corresponding ledge of another container, a cutting board, or other equipment. For example, the protruding portion(s) of a top-most container in a stack of two or more nestable containers may, when installed, rest upon a ledge of another container.

### DESCRIPTION OF THE FIGURES

FIG. 1 is a block diagram depicting a cutting board featuring multiple nestable containers within a cut-out, in accordance with some embodiments.

FIG. 2A is a block diagram of the cutting board of FIG. 1 with multiple nestable containers installed in a cut-out, in accordance with some embodiments.

FIG. 2B is a block diagram further depicting the cutting board of FIG. 1 with multiple nestable containers installed in a cut-out, in accordance with some embodiments.

FIG. 3 is a flow chart demonstrating a method of using a cutting board having one or more nestable containers installed in a cut-out section, in accordance with some embodiments.

FIG. 4A is a block diagram depicting a cutting board having a cut-out section for installation of nestable containers, in accordance with some embodiments.

FIG. 4B is a block diagram depicting the cutting board of FIG. 4A with multiple removable and nestable containers installed therein, in accordance with some embodiments.

FIG. 5 is a perspective view of nestable containers in accordance with some embodiments.

FIG. 6A is a side view of nestable containers aligned for nesting, in accordance with some embodiments.

FIG. 6B is a side view of the nestable containers of FIG. 6A with a first container positioned to receive a second container, in accordance with some embodiments.

FIG. 6C is a side view of the containers of FIG. 6A in their nested position, in accordance with some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

In some embodiments, a cutting board is provided that includes at least one cut-out or void for holding nestable or stackable containers. A cut-out may be fully or partially encircled by the cutting board. In these embodiments, the cutting board is placed on a counter or other support such that the cut-out is located beyond an edge of the support (e.g., over a sink, over open air). Some or all of the cutting board may be weighted so that it remains balanced and level even while food items and/or remnants are placed in the containers.

In some implementations, top edges of a container or of multiple containers installed in a cut-out are substantially flush with the top surface of a working or cutting area of the cutting board, while bottom ends of the containers extend below the bottom surface of the board. In these implementations, items on the work surface can be easily and cleanly wiped, scraped, or otherwise transferred to the container(s) with virtually no mess or spill and without lifting them from the cutting board.

In other embodiments, nesting or nestable containers are provided that nest within each other and/or within other compatible equipment. In these embodiments, a first container features one or more ledges for receiving and supporting lips, rims, or other protrusions of one or more other nesting containers. The other nesting containers may or may not also feature ledges for receiving other containers or apparatus, such as a lid or a strainer. In some implementations of these embodiments, no portion of a nested container (or other apparatus) rises above an upper rim, lip or edge of the container within which it is nested.

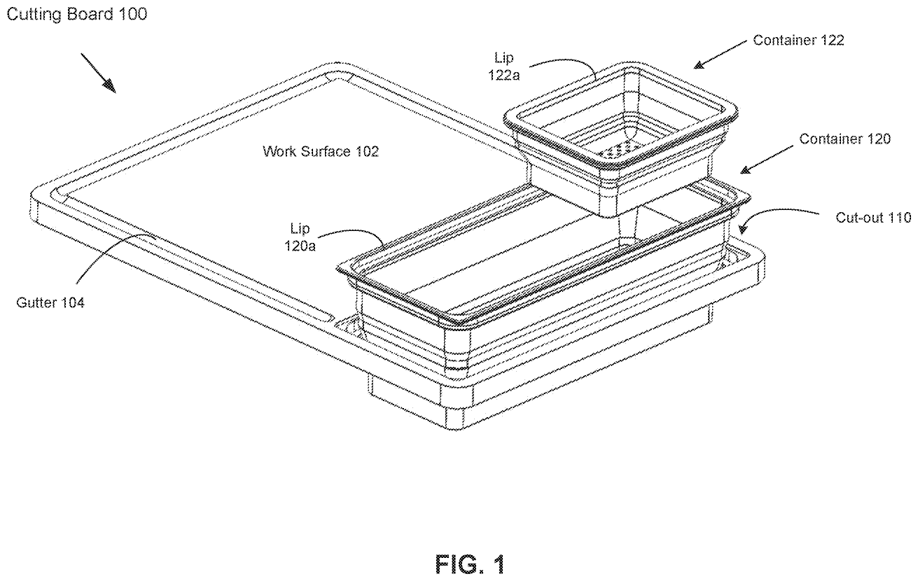

FIG. 1 is a block diagram depicting a cutting board featuring multiple nestable containers within a cut-out, according to some embodiments. In these embodiments, cutting board 100 features work surface 102, gutter 104, and cut-out 110. Cutting board 100, work surface 102, and cut-out 110 may be of various suitable dimensions and composition for cutting, chopping, grating and/or otherwise manipulating or preparing food and/or other items.

In some implementations, for example, work surface 102 may be approximately 14″ by 15″ while cut-out 110 is approximately 5″ by 15″. In other implementations, work surface 102 may be weighted to reduce the ratio of work surface area to cut-out area. For example, a weighted version of work surface 110 may be approximately 12″ by 12″ while cut-out 110 is approximately 6″ by 12″. These examples are merely illustrative and do not limit the dimensions of cutting board 100 or any component(s) of cutting board 100.

Gutter 104 may define one or more edges of work surface 102 but, in at least some embodiments, does not extend between work surface 102 and cut-out 110. Although cutting board 100 is rectangular in FIG. 1, with rounded corners, in other embodiments a cutting board may be square, elliptical or have some other regular or irregular shape.

Cut-out 110 of cutting board 100 accommodates multiple removable containers, including containers 120, 122, some or all of which may be stackable or nestable. Upon installation, edges of the containers are supported on some or all sides by a ledge or edge defining the cut-out. In FIG. 1, container 120 may be considered a ‘primary’ container in that it is placed first within cut-out 110, while container 122 may be considered a ‘secondary’ container because it stacks or nests within container 120.

A primary container may accept any number of secondary containers. Therefore, if container 122 is no longer than half the length of container 120, two or more of container 122 may be nested within container 120, side-by-side. Further, one or more of container 122 may be installed as primary containers, that is, they may be installed in cut-out 110 without container 120. Yet further, one or more containers smaller than container 122 may be stacked within container 122.

A container (e.g., container 120, container 122) may feature solid walls and a solid bottom, or one or more walls and/or a bottom may be open or perforated (e.g., to allow liquid to escape). For example, if container 120 has a perforated bottom (and/or if parts of one or more walls of the container are perforated), liquid may flow or seep from the container, possibly into a sink or basin placed below cut-out 110. Also, or alternatively, if the bottom or one or more walls of container 122 are perforated, liquid may flow or seep from container 122 into container 120, thereby allowing container 122 to act as a strainer. Yet further, a separate strainer implement may be installed on a container (e.g., as a top), and the resulting assembly (i.e., the strainer and one or more containers) may remain flush with work surface 102.

In some embodiments, during use of cutting board 100 container 120 is situated in cut-out 100 without any other containers when scraps or remnants on work surface 102 are to be removed from the surface. Container 120 may be emptied as necessary to dispose of the scraps. One or more of container 122 may then be nested in container 120 in order to receive food items or ingredients that are not to be disposed of. For example, as multiple different items (e.g., onion, carrot, tomato) are manipulated (e.g., diced, chopped) on work surface 102, the prepared ingredients may be wiped or scraped into one or more containers 122.

In some embodiments, cutting board 100 (e.g., work surface 102) is made from bamboo, wood, and/or a synthetic polymer that can withstand slicing, chopping and/or other actions with sharp instruments. Containers (e.g., containers 120, 122) may be made of silicon, glass, metal, and/or a natural or synthetic polymer.

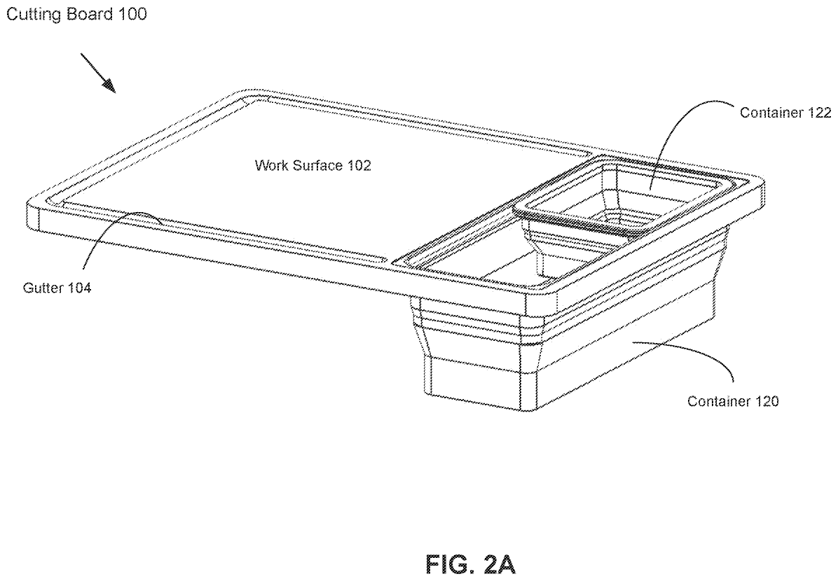

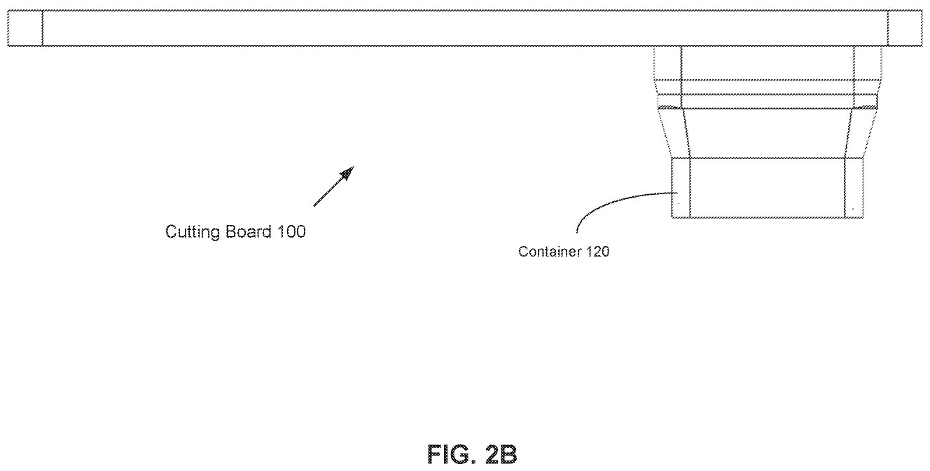

FIGS. 2A-B are block diagrams depicting cutting board 100 of FIG. 1 with nested containers installed in a cut-out, according to some embodiments. In FIG. 2A, a perspective view of cutting board 100 shows that the cut-out is populated with containers 120, 122. A lip or edge of the cut-out supports lip 120a of container 120 (shown in FIG. 1) along its some or all its circumference and, likewise, lip 120a of container 120 supports lip 122a of container 122 (shown in FIG. 1).

Illustratively, container 122 may be a strainer-type container, in which case a bottom of the container is perforated or pierced in some manner so that liquid moved into container 122 (e.g., liquid that accompanies food ingredients or scraps) passes through container 122 and into container 120. If container 120 is also of the strainer type, the liquid would also pass through container 120. In some implementations, multiple (e.g., two) of container 122 may be installed in container 120, with one of them being of the strainer type and another being of a collector type that features a closed bottom and walls so that whatever is placed in the container (e.g., liquid, solid) remains in the container.

FIG. 2B is a side view of cutting board 100, showing container 120 hanging from the cutting board and supported by cut-out 110. In particular, an edge or rim of container 120 engages a ledge or lip of cut-out 110 (not visible in FIG. 2B), which prevents the container from falling or passing through the cut-out. As shown in FIG. 2B, container 120 does not extend above the work surface of cutting board 100, and neither do any containers nested within container 120 (e.g., container 122).

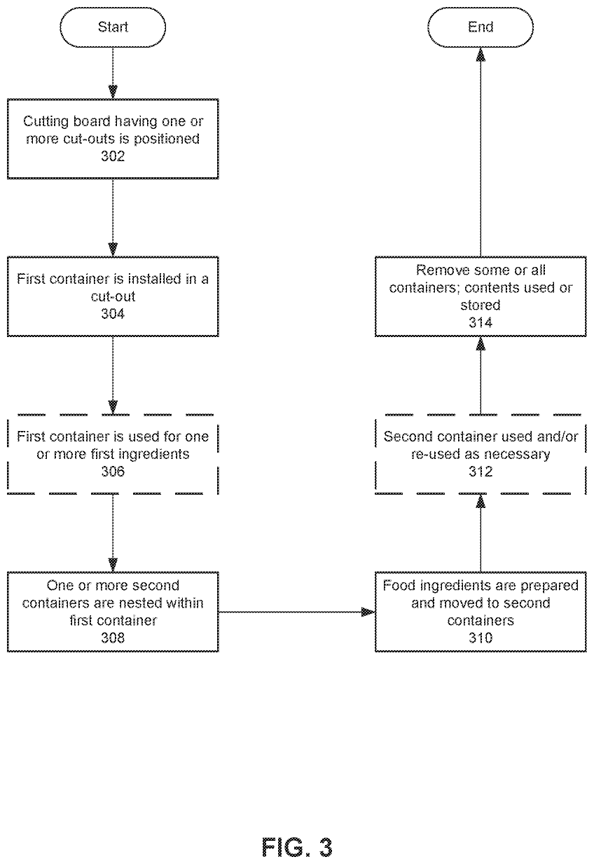

FIG. 3 is a flow chart demonstrating a method of using a cutting board in which nestable containers can be installed, according to some embodiments. In one or more embodiments, one or more of the steps may be omitted, repeated, and/or performed in a different order. Accordingly, the specific arrangement of steps shown in FIG. 3 should not be construed as limiting the scope of the embodiments.

In operation 302, a cutting board having one or more cut-out sections is placed on a counter or other support. Each cut-out is defined by a ledge, edge, or rim that extends around some or all the cut-out. In some implementations, the cut-out(s) extend beyond the counter and over a sink or open air. Therefore, while a work surface of the cutting board has immediate underlying support, the cut-out(s) have no immediate underlying support.

In operation 304, a first container is installed in a cut-out section, such that an outer edge or rim of the container catches on and is supported by the cut-out, thereby preventing the first container from falling through the cut-out. The first container does not extend above the plane of the working surface of the cutting board.

The first container may be a strainer type of container (with a bottom that is perforated or otherwise pierced) or a collector type (with a solid bottom), depending on a type of food ingredient to be prepared. For example, if tomatoes are to be diced and the liquid is not needed a strainer-type container may be installed or, if an ingredient having less liquid is to be prepared (e.g., carrot, apple, potato) a collector type of container may be installed.

In optional operation 306, one or more first ingredients are prepared and the ingredients and/or scraps are scraped or wiped into the first container. The first container may then be emptied (e.g., into a cooking pan or pot, into a trash can if it only contains scraps or remnants).

In operation 308, one or more second containers are nested within the first container, such that an outer edge or rim of each second container catches on and is supported by an inner edge or rim of the first container. None of the first and second containers extend above the plane of the working surface of the cutting board.

In operation 310, additional food ingredients are prepared (e.g., cut, sliced, chopped, minced) and moved into the second containers and/or (e.g., by removing a second container) the first container. If any of the additional food ingredients require straining, one or more of the second containers may be strainer-type containers, in which case the strained liquid will pass through to the first container and, if the first container is also a strainer-type container, will also pass through the first container (e.g., and into a sink).

In optional operation 312, one or more second containers may be swapped for other, empty, second containers or may be emptied (e.g., into a cooking vessel, into the trash) and re-installed for additional use with other ingredients.

In operation 314, either or both the first and second containers are removed from the cutting board cut-out(s). Contents of the containers may be used or placed appropriately; for example, one or more containers may be sealed with a lid to store or conserve their contents.

In some implementations, lids may be placed on the upper-most containers before, during, and/or after the containers are used. Although no container normally extends higher than the work surface of the cutting board, when a lid is placed on a container some or all the lid may extend above the plane of the work surface.

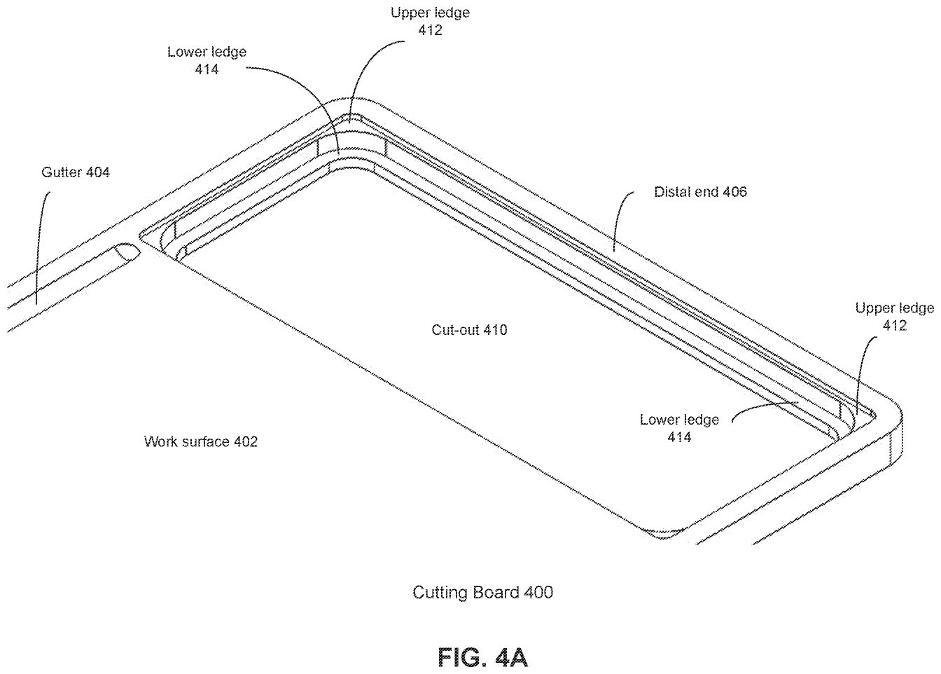

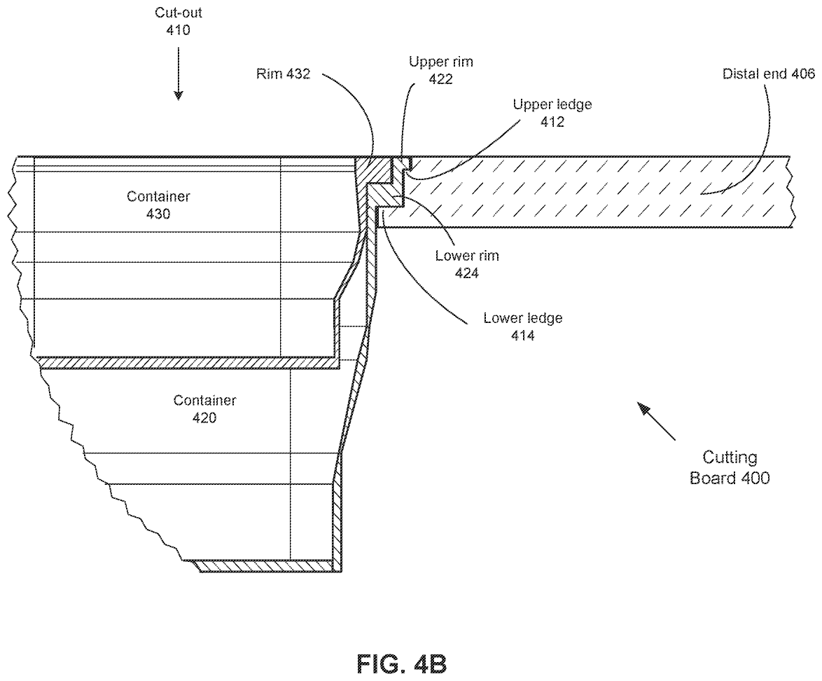

FIG. 4A is a block diagram depicting a cutting board having a cut-out section for installation of nestable containers, according to some embodiments.

In these embodiments, cutting board 400 includes work surface 402, gutter 404 and cut-out 410, similar to cutting board 100 of FIG. 1. FIG. 4 also illustrates distal end 406 of cutting board 400, which borders cut-out 410. Note that distal end 406 may be used as a handle for the cutting board.

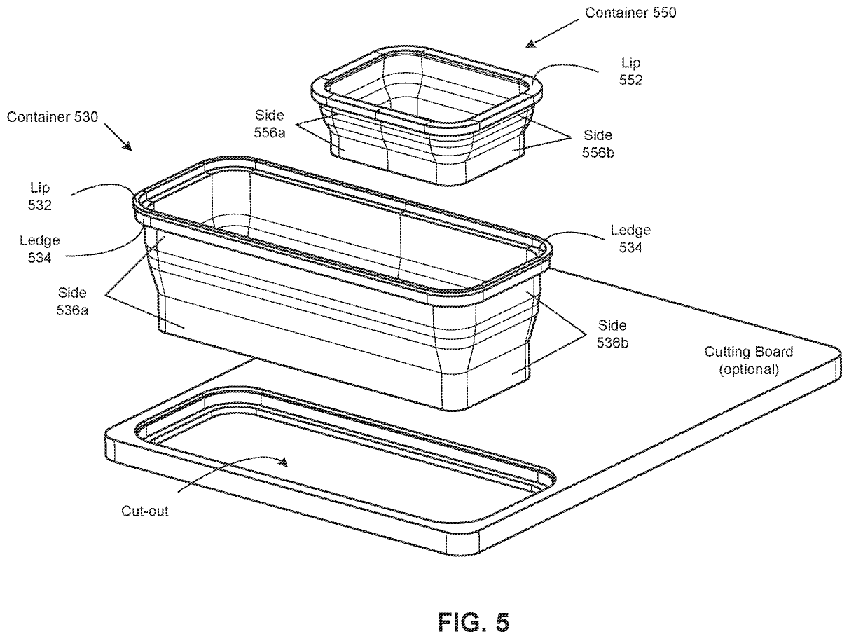

Cut-out 410 is defined by walls or edges that include upper ledge 412 and lower ledge 414. In some implementations, ledges 412, 414 surround the cut-out, while in other implementations they do not completely surround the cut-out. Operation of ledges 412, 414 is shown in more detail in FIG. 5.

FIG. 4B is a block diagram depicting the cutting board of FIG. 4A with multiple removable and nestable containers installed therein, according to some embodiments. In FIG. 4B, two containers (containers 420, 430) are nested within cut-out 410. Note that neither of the containers extends above the surface of distal end 406, which is coplanar with work surface 402.

Container 420 includes upper (or external) rim or edge 422, which engages or mates with (e.g., rests upon) upper ledge 412, and lower (or internal) rim or edge 424, which engages or mates with (e.g., rests upon) lower ledge 414. In the illustrated embodiments, lower portions of rims 422, 424 that are vertical abut, rather than rest upon, ledges 412, 414. Similarly, container 430 includes rim or edge 432, which engages with upper rim 422 and/or lower rim 424 of container 420. A lower, vertical portion of rim 432 abuts, rather than rests upon, lower rim 424. Sides and bottoms of the containers do not touch each other in the illustrated embodiments.

In some alternative embodiments in which more than two containers are nested without a cut-out, container 430 may include upper and lower rims or edges to engage with container 420 and another container nested within container 430.

FIG. 5 is a perspective view of nestable containers according to some embodiments. In these embodiments, container 550 can nest within container 530, which may be self-standing or may be installed within some other optional equipment, such as a cut-out within a cutting board.

Container 530 features lip 532, which forms some or all the perimeter of the opening of the container. Lip 532 is of uniform (or nearly uniform) height and thickness and, though shown as a continuous construct around the perimeter, in other implementations may be discontinuous. For example, lip 532 may appear on fewer than all sides of container 530 or may appear as a series of small lips with regular or irregular spacing instead of as a single extended lip.

A bottom or lower portion of lip 532 merges or melds into ledge 534, which may also be continuous or discontinuous around the perimeter of container 530. It can be seen in FIG. 5 (and in following figures) that lip 532 may slightly overhang ledge 534. In other words, in some implementations, the length and/or width of container 530 may be greater when measured from the outer edge of lip 532 on one side of the container to the outer edge of lip 532 on the opposite side than when measured at the outer edges of ledge 534. In other implementations, however, the outer surfaces of lip 532 and ledge 534 may be flush.

In contrast to container 530, container 550 features lip 552 but no ledge. Therefore, in these embodiments, container 550 is configured for use as a top-most container in a nest or stack. For example, container 550 may be a strainer-type container. As previously described, a lid may be installed in container 530 (i.e., on ledge 534) in place of container 550 or may be situated on top of container 550 while container 550 is nested within container 530.

As will be seen in other figures, when containers 530 and 550 are nested, the underside and/or outer surface of lip 552 of container 550 contact the upper surface of ledge 534 and/or the inner surface of lip 532 of container 530. However, the dimensions of the two containers are such that the sides (or side walls) and bottoms of the two containers do not touch. In particular, outer surfaces of sides 556 of container 550 do not touch inner surfaces of sides 536, and the underside of the bottom of container 550 (not shown in FIG. 5) does not contact the top surface of the bottom of container 530 (also not shown in FIG. 5). Similarly, in embodiments in which one or all nested containers are circular or semi-circular, no side wall of a given container touches a side wall of a container nested within the given container nor a side wall of a container in which the given container is nested.

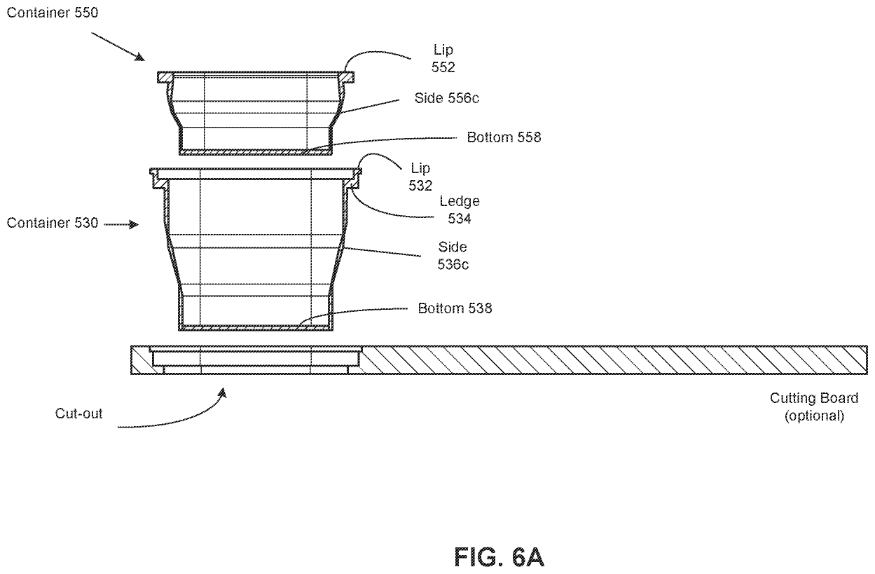

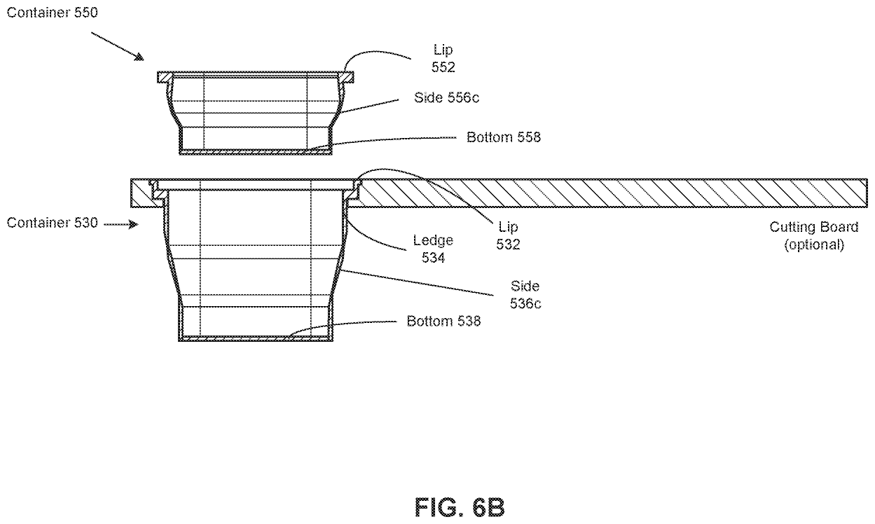

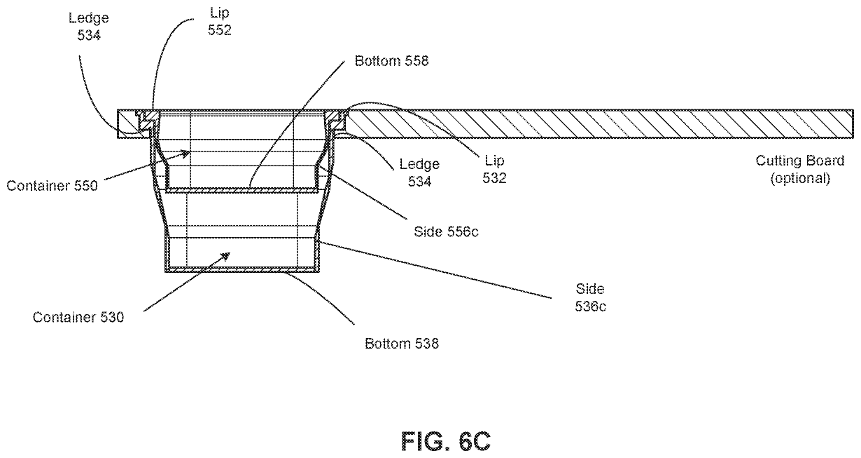

FIG. 6A is a side view of the nestable containers of FIG. 5 aligned for nesting, according to some embodiments. In this view, container 550 is aligned for nesting within container 530, which is aligned for nesting within another container or an article such as a cutting board having a cut-out configured to receive the container.

One may note that the outer contour of container 530 progresses downward and inward from lip 532 to ledge 534, to the sides of the container (e.g., side 536c), and to bottom 538. Similarly, the outer contour of container 550 proceeds downward and inward from lip 552 to the sides of the container (e.g., side 556c) to bottom 558. Although top-most container 550 nests directly within container 530 in the illustrated embodiments, in other embodiments one or more additional containers may be interposed and nested between them.

A container or article that receives container 530 will support, and contact, the underside of ledge 534 and/or the underside of the portion of lip 532 that overhangs ledge 534. Alternatively, container 530 may be self-standing, alone and/or when one or more containers (e.g., container 550) are nested within it.

FIG. 6B is a side view of the nestable containers of FIG. 5 with a first container in a stationary orientation and positioned to receive a second container, according to some embodiments. Although container 530 is installed or nested within a compatible cut-out of a cutting board in these embodiments, in other embodiments container 530 is installed in another (larger) container having surfaces that engage ledge 534 and/or lip 532, or that is self-standing. Container 550 is aligned above container 530.

FIG. 6C is a side view of the containers of FIG. 5 in a nested orientation, according to some embodiments. It can be seen in FIG. 6C that lip 552 of container 550 vertically engages and rests upon ledge 534 of container 530, and may be prevented from moving horizontally (or from moving more than a very short distance) by lip 532. As discussed above, bottom 558 of container 550 does not rest upon or contact bottom 538 of container 530. Similarly, outer side walls of container 550 (e.g., side 556c) do not contact inner side walls of container 530 (e.g., side 536c). However, a lower vertical (or nearly vertical) portion of lip 552 may contact a lower vertical (or nearly vertical) portion of ledge 534.

FIG. 6C demonstrates that, when container 550 is nested within container 530, no part of container 550 rises above container 530. Further, in some embodiments, lip 552 is configured such that a lid or strainer may be placed on lip 552 without rising above a highest point or surface of container 530.

Nesting containers may include one or more covers for covering or sealing the containers, perhaps for storage purposes (e.g., in a refrigerator or freezer). For example, because no nested containers rise above an upper edge, lip, or rim of container 530 in FIGS. 6A-C, a single cover may be provided that (tightly) fits lip 534 of container 530 and thereby covers container 530 and all containers nested within container 530.

As described previously, an upper nested container may be of various dimensions relative to the lower nested container in which it is installed, as long as it features an appropriately configured lip. For example, and with reference to FIG. 2A, an upper nested container (e.g., container 122 in FIG. 2A) may be notably shorter or narrower than a lower nested container (e.g., container 120 in FIG. 2A) in at least one dimension. This allows multiple upper nesting containers to be installed in a single lower nesting container. Thus, two of container 122 may be installed side-by-side in container 120 of FIG. 2A.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A set of nesting containers, comprising:
a first container having one or more first side walls supporting a ledge and a first lip; and
a second container having one or more second side walls supporting a second lip;
wherein the second lip of the second container rests upon the ledge of the first container when the second container is nested within the first container.

2. The set of nesting containers of claim 1, wherein no portion of the second container is higher than the first container when the second container is nested within the first container.

3. The set of nesting containers of claim 1, wherein no side wall of the second container contacts any side wall of the first container when the second container is nested within the first container.

4. The set of nesting containers of claim 1, wherein:
each of the first container and the second container comprises a bottom; and
the bottom of the second container does not contact the bottom of the first container when the second container is nested within the first container.

5. The set of nesting containers of claim 1, wherein the second container is a strainer-type container.

6. The set of nesting containers of claim 5, wherein the first container is a collector-type container.

7. The set of nesting containers of claim 1, further comprising:
a lid installable upon the second container;
wherein no portion of the lid is higher than the first container.

8. The set of nesting containers of claim 1, further comprising:
a third container having one or more third side walls supporting a second ledge and a third lip;
wherein the first container is nested within the third container; and
wherein no portion of the first container or the second container is higher than the third container.

9. The set of nesting containers of claim 1, wherein the first container is installed within a cut-out of a cutting board.

10. The set of nesting containers of claim 1, wherein one or both the first lip and the second lip are continuous about the side walls of the first container and the second container, respectively.

11. The set of nesting containers of claim 1, wherein one or both the first lip and the second lip are discontinuous about the side walls of the first container and the second container, respectively.

12. The set of nesting containers of claim 1, wherein the ledge of the first container is continuous about a circumference of the first container.

13. The set of nesting containers of claim 1, wherein the ledge of the first container is discontinuous about a circumference of the first container.

14. The set of nesting containers of claim 1, further comprising:
an additional second container having an additional second lip;
wherein both the second container and the additional second container are simultaneously nested within the first container.

15. The set of nesting containers of claim 1, further comprising at least one cover.
